(19) United States
(12) Patent Application Publication
(10) Pub. No.: US 2011/0175516 A1
(43) Pub. Date: Jul. 21, 2011

(54) BULB SHELL FOR LED LIGHT BULBS

(75) Inventors: CHIEN-HOUNG LIU, TAIPEI CITY (TW); YUNG-MING TSAO, KAOHSIUNG CITY (TW); YING-CHIEH TSAI, TAICHUNG CITY (TW)

(73) Assignee: LIGHTING DEVICE TECHNOLOGIES CORP., HSINCHU CITY (TW)

(21) Appl. No.: 12/907,367

(22) Filed: Oct. 19, 2010

(30) Foreign Application Priority Data
Jan. 20, 2010 (TW) 099201142

(51) Int. Cl. H01J 19/54

(52) U.S. Cl. 313/312

(57) ABSTRACT

A bulb shell includes a transparent shell base having an opening, a largest outer diameter and a light projection surface defined by a critical boundary on the shell base, and a coating on the shell base in a region between the opening and the critical boundary to increase brightness of the light projection surface. The critical boundary lies between a first position where the largest outer diameter is located and a second position distant from the first position by 33% of the dimension of the largest outer diameter in a direction away from the opening. The coating will significantly increase the brightness of the light projection surface when the bulb shell is used in a LED light bulb.

### FIELD OF THE INVENTION

The present invention is related to a bulb shell for light-emitting diode (LED) light bulbs.

### BACKGROUND OF THE INVENTION

Conventionally, in order to increase the brightness of a light projection surface of a LED light bulb, the LED light bulb is designed to use more LEDs or high power LED. However, either solution consumes more power and causes higher operating temperature of the LED. To maintain good performance of a LED, the operating temperature of the LED must be controlled within an appropriate range. Using more LEDs or high power LED will increase the operating temperature of the LED light bulb and thereby increase the cost of the heat sink required for maintaining the operating temperature of the LED light bulb. As a result, the total cost of the LED light bulb is increased.

### SUMMARY OF THE INVENTION

An object of the present invention is to provide a bulb shell for LED light bulbs to enhance the brightness of the light projection surface of the LED light bulbs.

According to the present invention, a bulb shell for LED light bulbs includes a transparent shell base having an opening, a largest outer diameter and a light projection surface defined by a critical boundary on the shell base, and a coating on the shell base in a region between the opening and the critical boundary to increase brightness of the light projection surface. The critical boundary lies between a first position where the largest outer diameter is located and a second position distant from the first position by 33% of the dimension of the largest outer diameter in a direction away from the opening.

In a LED light bulb having a bulb shell according to the present invention, the coating will reflect light emitted by the LED device of the LED light bulb and thus converge the light of the LED light bulb within a conical angle established by the LED device and the critical boundary. As a result, the brightness of the light projection surface may be increased up to more than twice, without increasing the cost and power consumption of the LED light bulb.

### BRIEF DESCRIPTION OF THE DRAWING

These and other objects, features and advantages of the present invention will become apparent to those skilled in the art upon consideration of the following description of the preferred embodiments of the present invention taken in conjunction with the accompanying drawings, in which:

FIG. 1 shows a bulb shell for LED light bulbs according to the present invention;

FIG. 2 is a diagram showing the light convergence of a LED light bulb having the bulb shell of FIG. 1;

FIG. 3 is a diagram showing a preferred region on the bulb shell of FIG. 1 for the critical boundary;

FIG. 4 is a diagram showing the critical boundary shifted toward the LED device of the LED light bulb shown in FIG. 2;

FIG. 5 is a diagram showing the critical boundary shifted away from the LED device of the LED light bulb shown in FIG. 2; and

FIG. 6 is a diagram showing a bulb shell having a rough surface for LED light bulbs.

### DETAILED DESCRIPTION OF THE INVENTION

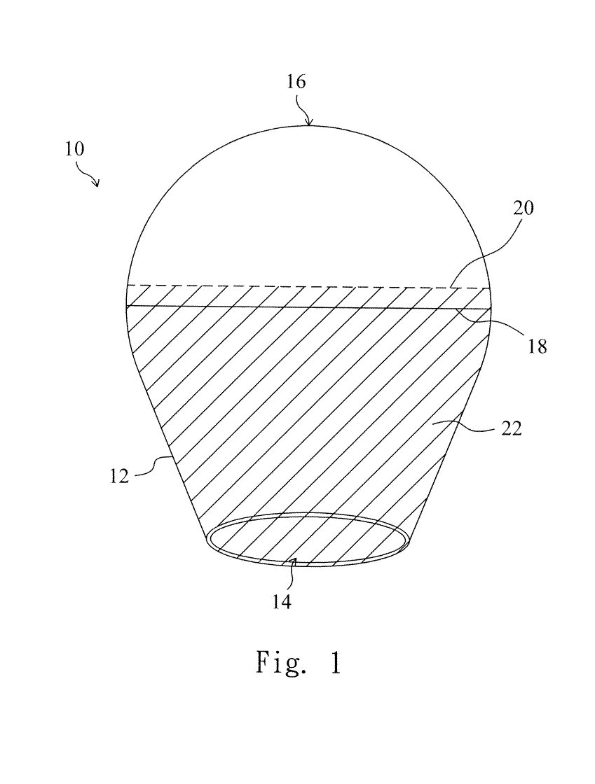

FIG. 1 shows a bulb shell 10 according to the present invention for LED light bulbs, which includes a transparent shell base 12 and a coating 22 thereon. The shell base 12 has an opening 14, a largest outer diameter 18 and a light projection surface 16 defined by a critical boundary 20. The coating 22 is coated in a region between the opening 14 and the critical boundary 20 to converge the light of the LED light bulb having the bulb shell 10 and thereby increase the brightness of the light projection surface 16. The shell base 12 is made of glass or plastic as is well known.

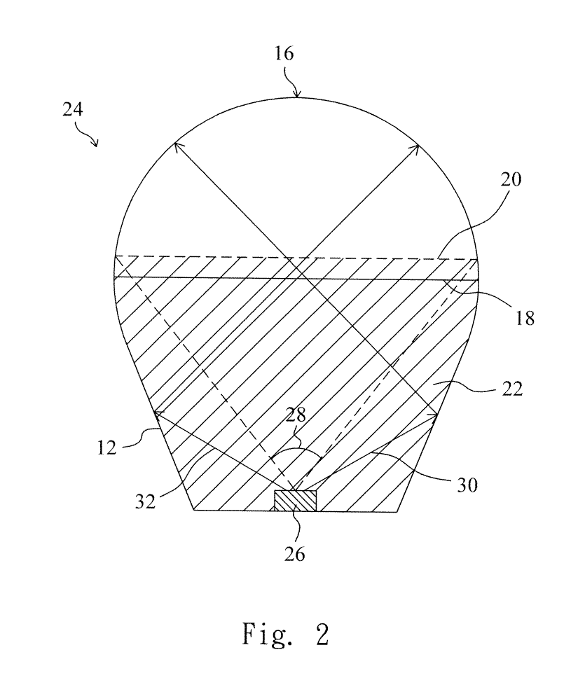

FIG. 2 shows the light convergence of a LED light bulb 24 having the bulb shell 10 of FIG. 1. With reference to FIGS. 1 and 2, a LED device 26 is disposed near the opening 14 of the bulb shell 10 to function as the light source of the LED light bulb 24 and thus establishes a conical angle 28 with the critical boundary 20. It is well known that a LED device typically has a light emission angle of between 110° and 120°, and the bulb shell 10 is so designed that the light emission angle of the LED device 26 will be wider than the conical angle 28 established by the LED device 26 and the critical boundary 20. The coating 22 includes a reflective film. Thus, the LED device 26 will have a portion of emitted light outside the conical angle 28, for example, the light rays 30 and 32, being reflected by the coating 22 and then projecting outward through the light projection surface 16. As a result, the light of the LED light bulb 24 is converged within the conical angle 28, and the brightness of the light projection surface 16 is enhanced due to the light convergence. In an embodiment, the coating 22 includes a metal layer, e.g., an aluminum layer with a purity of 99.9%, formed by a vapor deposition onto a portion of the inner surface of the shell base 12 in a vacuum chamber. Preferably, the coating 22 is thick enough to prevent the light emitted by the LED device 26 from passing therethrough to thereby maximize the light density on the light projection surface 16.

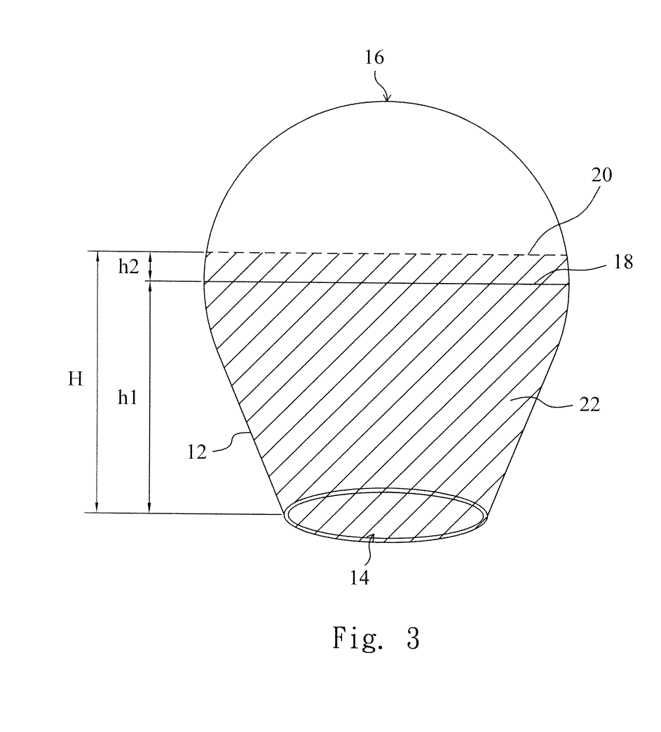

FIG. 3 is a diagram showing a preferred region on the bulb shell 10 for the critical boundary 20. Referring to FIGS. 2 and 3, in order for the light emitted by the LED device 26 to be projected outward through the light projection surface 16 in a concentrated manner, the critical boundary 20 is arranged between a first position where the largest outer diameter 18 is located and a second position distant from the first position by 33% of the largest outer diameter 18 in the direction away from the opening 14. For clearer explanation, assuming that the distance between the first position where the largest outer diameter 18 is located and the opening 14 is h1, then the distance between the critical boundary 20 and the opening 14 is H=h1+h2, where h2 ranges from zero to 33% of the largest outer diameter 18. In an embodiment, the largest outer diameter 18 is 60 mm, and the distance h2 ranges from 0 mm to 20 mm (i.e., approximately 33% of the largest outer diameter 18), and is preferably 3 mm (i.e., 5% of the largest outer diameter 18), in which case the brightness observed above the light projection surface 16 is more than twice as high as when the bulb shell 10 is not coated with the coating 22. In another embodiment, the largest outer diameter 18 is 75 mm, and the distance h2 ranges from 0 mm to 20 mm (i.e., approximately 27% of the largest outer diameter 18), and is preferably 3 mm (i.e., 4% of the largest outer diameter 18), in which case the brightness observed above the light projection surface 16 is more than twice as high as when the bulb shell 10 is not coated with the coating 22. Thus, the brightness of the light projection surface 16 is significantly increased.

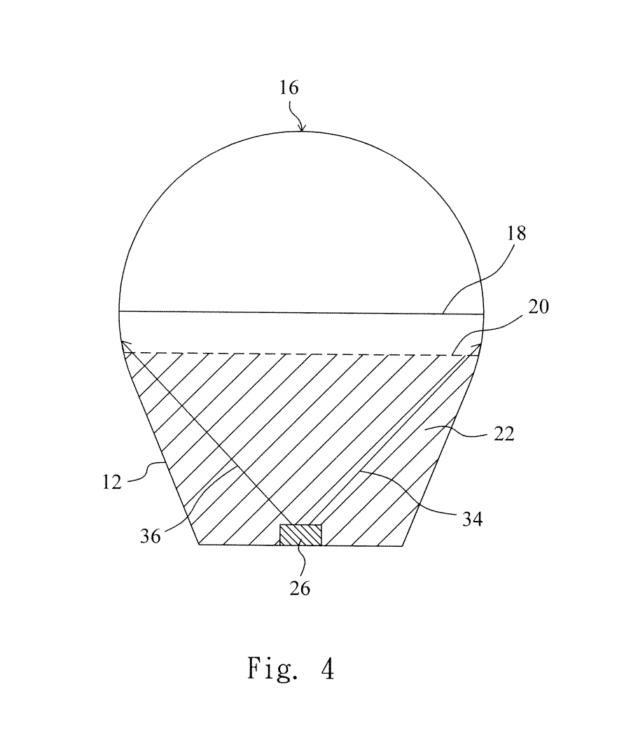

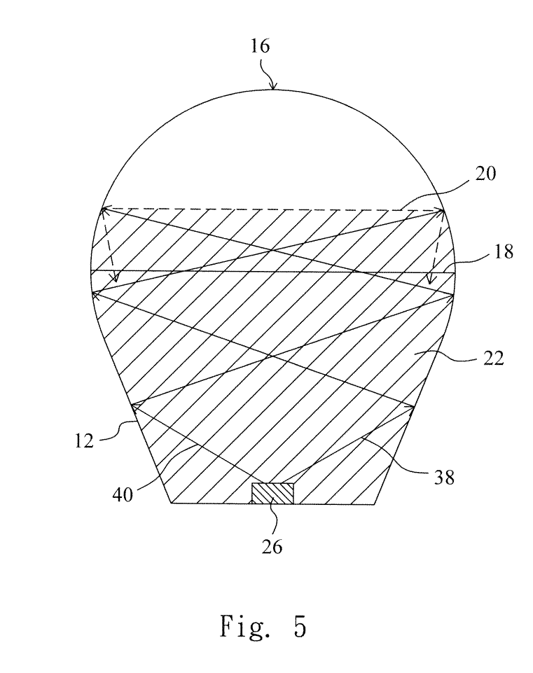

The brightness of the light projection surface 16 is affected by the location of the critical boundary 20. For instance, referring to FIG. 4, when the critical boundary 20 is shifted toward the LED device 26 beyond the range specified above, some of the light emitted by the LED device 26, e.g., the light rays 34 and 36, will directly project outward through the lateral side of the shell base 12 and hence the brightness of the light projection surface 16 will not be increased as much as when the critical boundary 20 is within the specified range. On the other hand, referring to FIG. 5, when the critical boundary 20 is shifted away from the LED device 26 beyond the range specified above, some of the light emitted by the LED device 26, e.g., the light rays 38 and 40, will be reflected repeatedly in the shell base 12 without projecting outward through the light projection surface 16. As a result, loss of light occurs, which reduces rather than increases the brightness of the light projection surface 16. In short, the brightness of the light projection surface 16 will not be significantly increased if the critical boundary 20 is disposed too high or too low.

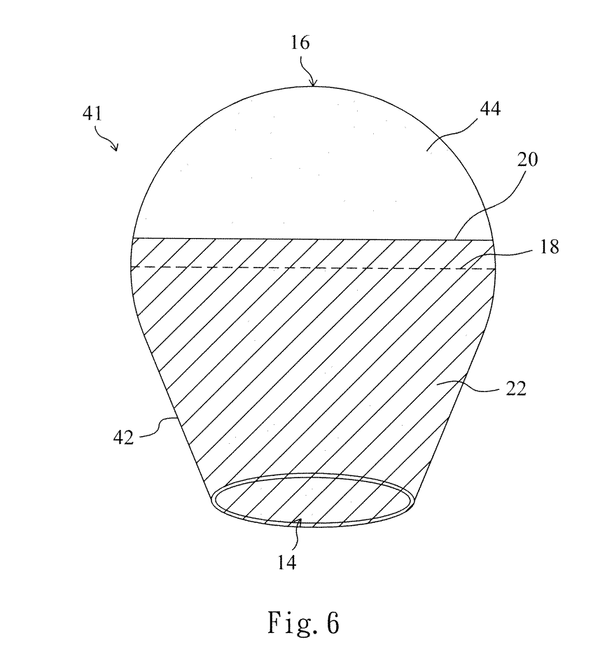

Referring to FIG. 6, a bulb shell 41 includes a transparent shell base 42 with a rough surface 44 and a coating 22 on a portion of the inner surface of the shell base 42. The rough surface 44 may be formed by a frosting treatment. For example, either of or both the inner and outer surfaces of the shell base 42 is etched with a liquid mixture of HF, NH₄HF₂ and H₂SO₄, or a liquid mixture of HF, NH₄F and H₂SO₄, or a solution made by dissolving fluorite powder in sufficient H₂SO₄, or a solution made by dissolving NH₄F or BaS₂O₃.H₂O in HF or oleum (a solution of 100% H₂SO₄ containing free SO₃). As a light guide or the like, the rough surface 44 on the light projection surface 16 enables light diffusion. If the rough surface 44 is formed on the inner surface of the shell base 42, it also enhances the adhesion of the coating 22 onto the inner surface of the shell base 42. Alternatively, the frosting treatment can be carried out by other processes, for example, by applying sandblasting, chemical etching, nanomaterial coating, or UV glue material coating to either of or both the inner and outer surfaces of the shell base 42.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A bulb shell for LED light bulbs, comprising:
a transparent shell base having an opening, a largest outer diameter and a light projection surface defined by a critical boundary on the shell base; and
a coating on the shell base in a region between the opening and the critical boundary to increase brightness of the light projection surface;
wherein the critical boundary lies between a first position where the largest outer diameter is located and a second position distant from the first position by 33% of the dimension of the largest outer diameter in a direction away from the opening.

2. The bulb shell of claim 1, wherein the critical boundary is at a position distant from the first position by 4% of the dimension of the largest outer diameter in the direction away from the opening.

3. The bulb shell of claim 1, wherein the critical boundary is at a position distant from the first position by 5% of the dimension of the largest outer diameter in the direction away from the opening.

4. The bulb shell of claim 1, wherein the critical boundary is at a position distant from the first position by 27% of the dimension of the largest outer diameter in the direction away from the opening.

5. The bulb shell of claim 1, wherein the shell base has a rough surface.

6. The bulb shell of claim 1, wherein the shell base is made of glass or plastic.

7. The bulb shell of claim 1, wherein the coating is on a portion of an inner surface of the shell base.

8. The bulb shell of claim 1, wherein the coating comprises a reflective film.

9. The bulb shell of claim 8, wherein the reflective film comprises a metal.

10. The bulb shell of claim 9, wherein the metal comprises aluminum.
